(19) United States
(12) Patent Application Publication
(10) Pub. No.: US 2003/0058863 A1
(43) Pub. Date: Mar. 27, 2003

(54) Method for transmitting compressed data in packet-oriented networks

(75) Inventor: Johan Oost, Asper (BE)

Correspondence Address: STAAS & HALSEY LLP, 700 11TH STREET, NW, SUITE 500, WASHINGTON, DC, 20001, US

(73) Assignee: Siemens Aktiengesellschaft, Munich (DE)

(21) Appl. No.: 10/256,209

(22) Filed: Sep. 27, 2002

(30) Foreign Application Priority Data
Sep. 27, 2001 (DE) 101 47 773.2

(51) Int. Cl. H04L 12/28

(52) U.S. Cl. 370/392

(57) ABSTRACT

The method transmits compressed data in packet-oriented networks. Before data packets are forwarded to a second network node device, a first network node device is used to check a compression state for the data contained in the data packets. In addition, a database entry characterizing the second network node device is evaluated. Message header entries in the data packets are modified on the basis of the characterizing entry and on the basis of the presence of the compression state.

### CROSS REFERENCE TO RELATED APPLICATIONS

This application is based on and hereby claims priority to German Application No. 101 47 773.2 filed on Sep. 27, 2002, the contents of which are hereby incorporated by reference.

### BACKGROUND OF THE INVENTION

The invention relates to a method and to a system for transmitting compressed data in packet-oriented networks.

The continually increasing interchange of information places great demands on infrastructures for transmitting this information. In the face of current development, the avoidance of bottlenecks during information transmission requires continual expansion of packet-oriented networks transmitting information.

Another way of avoiding bottlenecks is to compress data which are to be transmitted via packet-oriented networks. The literature has disclosed numerous methods which aim to reduce the volume of information and hence to achieve faster data throughput with little memory requirement. The principle of this data compression is based on the elimination of redundant characters and on dynamic assignment of data bits on the basis of the frequency of a character.

The protocol HTTP (Hypertext Transfer Protocol) frequently used in packet-oriented networks is used for information interchange between a control computer (server) and a client application, such as a browser. Version 1.1 of the HTTP protocol is implemented in many current browsers and supports data compression on the basis of the “GZIP” method, which is described in the document by Deutsch, P. et. al., RFC1952 (Request for Comment): “GZIP File Format Specification”, version 4.3, May 1996. The HTML 1.1 protocol is specified in the document by Fielding, R. et. al., RFC2068: “Hypertext Transfer Protocol-HTTP/1.1”, January 1997.

Even though this data compression—e.g. based on the HTTP 1.1 protocol—ensures a considerable reduction in the volume of data without loss of information following successful decompression at their respective opposite communication endpoint, the use of such data compression is limited to the cases in which both communication endpoints have access to the coding and decoding algorithms specific to the respective data compression method.

It is one possible object of the invention to specify a method which allows more flexible use of data compression when transmitting information via a packet-oriented network.

### SUMMARY OF THE INVENTION

According to one aspect of the invention, network node devices—for example routers or else a communication endpoint itself—carry out a check, before a data packet is forwarded to a further network node device, on the compression state of the data transmitted in the data packets and evaluate a database entry characterizing the further network node device. A message header entry—often referred to as a header in the technical field—in the data packet is modified on the basis of the characterizing entry and on the basis of the presence of the compression state.

A fundamental advantage of the method can be seen in that modification of the message header entry and consideration of a database entry characterizing the next network node device allow compressed data packets to be identified and routed using resources of the network node devices, as opposed to this first being done at the communication endpoints.

Advantageously, an uncompressed data packet is compressed on the network node device.

A port number defined, by way of example, on the basis of the TCP protocol (Transfer Control Protocol) is advantageously used to characterize the compression state.

A particular advantage is that a dedicated port number is assigned in the message header of compressed data packets. This port number, corresponding to a typical port number, is used to indicate that the respective data packet contains compressed data, without needing to change the structure of the message header in order to hold this information.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a structogram for schematically illustrating packet-oriented connection paths between two network node devices designed in accordance with one embodiment of the invention; and

FIG. 2 shows a structogram for schematically illustrating a connection path between two network node devices designed in accordance with one embodiment of the invention and a further network node device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

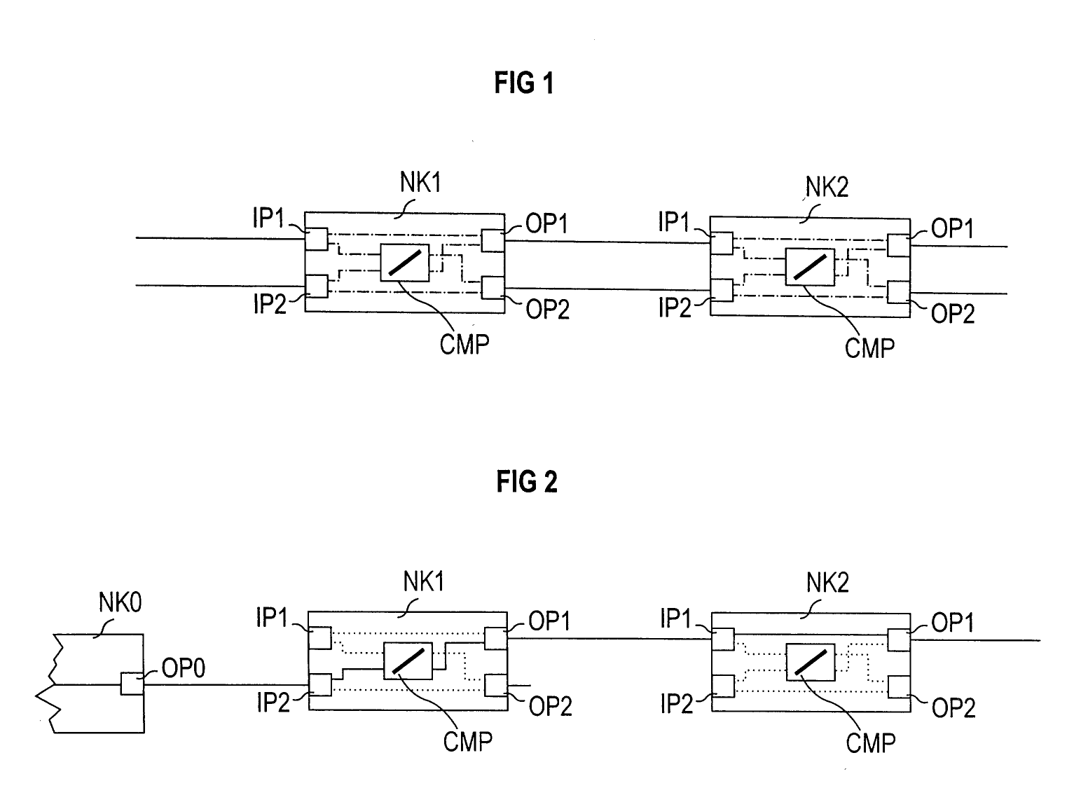

FIG. 1 shows two network node devices NK1, NK2 of identical design. These are routers which connect a plurality of packet-oriented networks—not shown—or else “subnetworks”—not shown—to one another within a packet-oriented network on layer 3 (network layer) of the OSI reference model (Open Systems Interconnection) from the International Standardization Organization ISO. In addition to functional units—not shown—associated with conventional routers, the network node devices NK1, NK2 have a compression/decompression unit CMP.

Furthermore, the two network node devices NK1, NK2 each have two logical inputs IP1, IP2 and two logical outputs OP1, OP2. Shown diagrammatically in dash-dot lines between the two inputs IP1, IP2 and the two outputs OP1, OP2 are possible processing paths for data within the network node devices. Connection paths between the network node devices NK1, NK2 are shown as lines.

Uncompressed data arriving at the input IP1 are either forwarded directly to the output OP1 or are compressed by the compression/decompression unit CMP and forwarded to the output OP2. Compressed data arriving at the input IP2 are either forwarded directly to the output OP2 or are decompressed by the compression/decompression unit CMP and forwarded to the output OP1.

The output OP1 of the first network node device NK1 is connected to the input IP1 of the second network node device NK2, and the output OP2 of the first network node device NK1 is connected to the input IP2 of the second network node device NK2.

In packet-oriented networks, there are no fixed connection paths. Accordingly, the lines shown in dash-dot form and in solid form in the drawing are to be understood to be a diagrammatic representation of possible connection paths in a—connectionless—packet-oriented network. In addition, the second network node device NK2 is just one possible connection partner for the first network node device NK1.

Information is transmitted in a packet-oriented network using individual data packets which each contain a characterizing message header entry—often referred to as a header in the technical field—and a data segment containing the actual information. In this case, the message header entry contains information about a communication endpoint, that is to say, by way of example, a logical destination address for the data packet.

The inputs and outputs IP1, IP2; OP1, OP2 are consequently not to be understood to be functional units, but rather serve to give a structured diagrammatic representation of logical communication endpoints for a data packet. Since communication in a packet-oriented network takes place bidirectionally, the terms inputs and outputs are not to be understood as restrictive indications of direction, but rather serve to give a diagrammatic representation of a way in which data packets are processed.

Data packets are transmitted to their communication endpoint within a packet-oriented network via a plurality of intermediate stations, each intermediate station containing information about the respective further intermediate stations connected to it. In this case, a control device provides the respective intermediate station with a choice of next intermediate station on the basis of criteria such as QoS (Quality of Service), a data transfer rate which can be expected, etc., in the form of routing tables. In this context, the control device sets the next intermediate station using an entry for a corresponding address in the message header entry. The two network node devices NK1, NK2 each have such a routing table—not shown—and a control device—not shown—for setting the next intermediate station.

An example of a logical communication endpoint is a hardware and/or software structure, often referred to as “socket” in the technical field. A socket is referred to by a network number, a computer number and a port number. Sockets are the basis for implementations of a packet-oriented network based on a specification known to the person skilled in the art as the TCP/IP standard (Transfer Control Protocol/Internet Protocol). As an alternative to the TCP protocol, it is also possible to use UDP (User Datagram Protocol) or other transport protocols.

The message header entry in a data packet contains an entry characterizing the port number. Allocation of the port numbers serves to identify different data streams that are processed simultaneously in the TCP protocol. These port numbers are used for interchanging data between application processes distributed in a packet-oriented network. These port numbers are allocated to application processes dynamically and randomly. For particular, frequently used application processes, however, the IANA (Internet Assigned Numbers Authority) allocates permanent port numbers, which are often referred to in the technical field as typical port numbers or else as “assigned numbers” or “well known numbers”.

The diagrammatic inputs and outputs IP1, IP2; OP1, OP2 on the network node devices NK1, NK2 are thus to be understood to be data packet communication endpoints associated with logical port numbers. In this case, a first input/output pair IP1, OP1 has an associated typical—for an application process—port number, and a second input/output pair IP2, OP2 has an associated corresponding port number.

On the basis of these introductory illustrations, the method for transporting compressed data in packet-oriented networks is described in more detail below.

To simplify illustration, the text below explains merely an application process based on the WWW/HTTP protocol (World Wide Web/Hypertext Transfer Protocol) which has the associated typical port number “80”. The corresponding port number defined for this application process is the port number “60”, which has not been allocated by the IANA and is accordingly available for a definition.

Other services or application processes, such as SMTP (Simple Mail Transfer Protocol), FTP (File Transfer Protocol) etc., each have their typical port number and a corresponding port number associated with them in the network node devices NK1, NK2; these are not illustrated in the drawing and in the description for reasons of space, however, but the method can also be carried out for these services and application processes in a similar way to in the exemplary embodiment described here.

The port with the port number “60”, which port corresponds with the port number “80” for the application process HTTP, is defined as “compressed HTTP” and is referred to below as CHTTP (“Compressed HTTP”) for short. The first input/output pair IP1, OP1 on the first and second network node devices NK1, NK2 is assigned to receiving and forwarding data packets whose indication, located in the message header, of the port number “80” associates them with the application process HTTP. The second input/output pair IP2, OP2 on the first and second network node devices NK1, NK2 is assigned to receiving and forwarding data packets whose indication, located in the message header, of the port number “60” associates them with the application process HTTP but which, unlike data packets having the port number “80”, contain compressed data (CHTTP) based on the HTTP protocol in their data segment.

The input IP1 on both network node devices NK1, NK2 diagrammatically represents data packets which arrive at the respective network node device NK1, NK2 with the port number “80” in the message header entry and contain uncompressed data based on the HTTP protocol in their data segment.

The input IP2 on both network node devices NK1, NK2 diagrammatically represents data packets which arrive at the respective network node device NK1, NK2 with the port number “60” in the message header entry and contain compressed data based on the CHTTP protocol in their data segment.

The output OP1 on both network node devices NK1, NK2 diagrammatically represents data packets which are forwarded with the port number “80” in the message header entry from the respective network node device NK1, NK2 to the next intermediate station and contain uncompressed data based on the HTTP protocol in their data segment.

The output OP2 on both network node devices NK1, NK2 diagrammatically represents data packets which are forwarded with the port number “60” in the message header entry from the respective network node device NK1, NK2 to the next intermediate station and contain compressed data based on the CHTTP protocol in their data segment.

The first network node device NK1 can select the network node device NK2 designed in accordance with the invention as the next intermediate station. That means that this network node device NK2 likewise has a CHTTP port and can use the compression/decompression unit CMP to compress data received in uncompressed form and to decompress data received in compressed form. This configuration of the second network node device NK2 is known by virtue of a corresponding entry in the routing table in the first network node device NK1.

Processing of data packets is explained below.

FIG. 2 shows the system of the first and second network node devices NK1, NK2. The possible processing paths for the data within the network node devices NK1, NK2, as shown in dash-dot lines in FIG. 1, are now shown in dotted lines and in a solid line, the solid line showing the actual processing path for the possible processing paths—shown as dotted lines. As in FIG. 1, a solid line also shows the path for data packets through the packet-oriented network.

A further network node device NKO communicates with the first network node device NK1 in the course of an interchange of data packets. This further network node device NKO can be a router, or else—as assumed below—a communication endpoint NKO. The communication endpoint NKO does not support a CHTTP protocol and transmits uncompressed data packets with the port number “80” to the first network node device NK1. Data packets with the port number “80” are received at the second input IP2 of the first network node device NK1. Using routing tables, the second network node device NK2 is selected as a destination for forwarding these data packets, an entry in the routing table indicating that said second network node device has a CHTTP port and is able to compress data received in uncompressed form and to decompress data received in compressed form using the compression/decompression unit CMP. The data packets are then supplied to the compression/decompression unit CMP within the first network node device NK1.

The decision to supply the data to the compression/decompression unit CMP is made by a control logic unit—not shown. If system resources in the first network node device NK1 are not sufficient for arithmetically complex compression, e.g. on account of the utilization level of a processor—not shown—or of a main memory—not shown—, the control logic unit prompts uncompressed forwarding to the next network node device NK2.

Compression of the data packets by the compression/decompression unit CMP includes data taken from the data segments in a plurality of data packets. This compression is concluded according to current compression techniques with subsequent defragmentation of the data and packetization into data packets.

The port number in the message header entry is set to the port number for CHTTP data “60”, which port number corresponds to the HTTP protocol. The entries in the message header entry for the network number and for the computer number remain the same, however. The compressed data packets are forwarded from the compression/decompression unit CMP to the first output OP1 of the network node device NK1.

At the second network node device NK2, these data packets are identified as CHTTP data from the corresponding port number “60” and are received at the input IP1. If an entry in the routing table in the second network node device NK2 indicates that the network node device—not shown—coming after the second network node device NK2 or else the communication endpoint—not shown—coming after the second network node device NK2 has a CHTTP port itself and is able to use the compression/decompression unit CMP to compress data received in uncompressed form and to decompress data received in compressed form, the data packets are forwarded in the compressed state and with the port number “60” retained. The drawing shows this case using the solid line at the first output OP1 and between the first input IP1 and the first output OP1.

If the network node device—not shown—coming after the second network node device NK2 or the communication endpoint—not shown—coming after the second network node device NK2 does not have a CHTTP port, according to an entry in the routing table, the compressed data packets are instead supplied to the compression/decompression unit CMP and the port number in the message header entries in the decompressed data packets is set to the value “80” associated with the HTTP protocol.

The invention has been described in detail with particular reference to preferred embodiments thereof and examples, but it will be understood that variations and modifications can be effected within the spirit and scope of the invention.

What is claimed is:

1. A method for transmitting compressed data in data packets from a first network node device to a second network node device, comprising:
checking a compression state for the data contained in the data packets;
evaluating a database entry characterizing the second network node device; and
modifying message header entries in the data packets on the basis of the database entry and on the basis of the compression state, to thereby produce modified packets; and
forwarding the modified packets from the first network node device to the second network node device.

2. The method as claimed in claim 1, wherein, in the event that data packets arrive at the first network node device in an uncompressed form, the data packets are compressed at the first network node device before they are forwarded to the second network node device.

3. The method as claimed in claim 2, wherein data packets are compressed at the first network node device only if there are sufficient system resources available.

4. The method as claimed in claim 1, wherein
the network node devices manage logical ports which are used for sorting data streams comprising associated data packets according to data format, and
the logical ports are identified by respective port numbers.

5. The method as claimed in claim 4, wherein selected port numbers are reserved for frequently used application processes associated with an interchange of data streams having particular data formats.

6. The method as claimed in claim 5, wherein if an uncompressed data stream has a particular data format, which has a reserved port number, the method further comprises assigning an unreserved port number to a compressed data stream corresponding to the uncompressed data stream.

7. The method as claimed in claim 6, further comprising:
selectively changing the compression/decompression state of a data stream received at the first network node device, and
modifying a message header entry in the data packets if the compression/decompression state is changed, to change the port number.

8. The method as claimed in claim 7, wherein the assigned port number in the message header entry in a compressed data stream is retained and data packets received at the first network node device are forwarded without changing the compression state, to the second network node device if the database entry for the second network node device indicates that the assigned port number is supported.

9. The method as claimed in claim 7, wherein the reserved port number in the message header entry in an uncompressed data stream is changed to the corresponding assigned port number, and uncompressed data packets received at the first network node device are compressed before being forwarded to the second network node device if the database entry for the second network node device indicates that the assigned port number is supported.

10. The method as claimed in claim 9, wherein compression involves defragmenting the data.

11. The method as claimed in claim 7, wherein the assigned port number in a compressed data stream is changed to the corresponding reserved port number, and compressed data packets received at the first network node device are decompressed before forwarding, if the database entry for the second network node device indicates that the assigned port number is not supported.

12. The method as claimed in claim 7, wherein the reserved port number in an uncompressed data stream is retained and uncompressed data packets received at the first network node device are forwarded to the second network node device without changing the compression state if the database entry for the second network node device indicates that the corresponding assigned port number is not supported.

13. The method as claimed in claim 1, wherein data packets in the network node device are forwarded with a prioritization for their compression state.

14. The method as claimed in claim 1, wherein the first network node device is in the form of a router.

15. The method as claimed in claim 1, wherein the first network node device is in the form of a bridge.

16. The method as claimed in claim 1, wherein
the database entry is contained in a database, and
the database is a dynamic routing table.

17. The method as claimed in claim 1, wherein
the database entry is contained in a database, and
the database is a static routing table.

18. A first network node device for transmitting data packets to a second network node device in a packet-oriented network, comprising:
an evaluation unit to check a compression state for data contained in the data packets and to evaluate a database entry characterizing the second network node device;
a compression/decompression unit to modify message header entries in the data packets on the basis of the database entry and on the basis of the compression state, to thereby produce modified data packets; and
a transmission unit to forward the modified data packets from the first network node device to the second network node device.

19. The network node device as claimed in claim 18, wherein the first network node device is a local area network (LAN) network node device.

20. The network node device as claimed in claim 18, wherein in the event that data packets arrive at the first network node device in uncompressed form, the compression/decompression unit compresses the data packets before the transmission unit forwards the data packets to the second network node device.
